(19) United States
(12) Patent Application Publication
(10) Pub. No.: US 2017/0013804 A1
(43) Pub. Date: Jan. 19, 2017

(54) PET RESTRAINT WITH DEPLOYABLE PROTECTIVE SHIELD

(71) Applicants: George J. Fachner, SR., Marlboro, NJ (US); Catherine Napolitano, Marlboro, NJ (US)

(72) Inventors: George J. Fachner, SR., Marlboro, NJ (US); Catherine Napolitano, Marlboro, NJ (US)

(21) Appl. No.: 15/209,192

(22) Filed: Jul. 13, 2016

Related U.S. Application Data
(60) Provisional application No. 62/191,931, filed on Jul. 13, 2015.

(51) Int. Cl. A01K 13/00; A01K 27/00

(52) U.S. Cl. CPC A01K 13/006; A01K 27/001; A01K 27/002; A01K 27/008; A01K 27/003

(57) ABSTRACT

A pet restraint with integrated protective shield. The restraint may be one of a collar or harness carrying a pouch at a top portion. The protective shield is stored within the pouch and may be deployed so as to cover and protect the pet's back and sides. The protective shield may be one or more of a raincoat, a thermal blanket, or a solar shield.

### CROSS-REFERENCE TO RELATED APPLICATION

This application claims the benefit of priority of U.S. provisional application No. 62/191,931, filed Jul. 13, 2015, the contents of which are herein incorporated by reference.

### BACKGROUND OF THE INVENTION

The present invention relates to pet restraints, such as collars or harnesses and, more particularly, to protective gear to shield a pet from adverse environmental conditions, such as rain or cold. Conventionally, pet protective gear, such as a raincoat, is a separate item that a pet owner would have to put on their pet prior to taking their pet for a walk. Moreover, some pets may not be amenable to being dressed in protective gear and fitting such protective gear may be difficult to achieve. Similarly, if inclement weather came up unexpectedly, a pet owner may have left the house without protective gear for their pet and the pet would be exposed to the adverse environmental elements.

As can be seen, there is a need for pet protective gear that is readily adapted to be fitted to a pet, should environmental conditions warrant.

### SUMMARY OF THE INVENTION

In one aspect of the present invention, pet restraint, includes a collar configured to be releasably secured around a neck of a pet; a pouch secured to a top portion of the collar, the pouch having an interior cavity defined therein and an opening between an exterior of the pouch and the interior cavity; and a protective shield having a front portion attached within the interior cavity and an aft portion that is selectably deployed between a stowed condition within the pouch and a deployed condition to substantially cover a back of the pet. The opening may be selectively opened and closed by a fastener, such as a zipper, a hook and pile fastener, or a snap.

In some embodiments, the pet restraint may also have a torso band configured to be releasably secured around a torso of the pet; and a back strap interconnecting the torso band and the collar. The pet restraint may also have a chest portion attached to a lower portion of the collar and extending to interconnect with a bottom portion of the torso band. A restraint ring is operatively attached to the pet restraint, and may be attached to the top portion of the collar, to the back strap.

In other aspects of the invention, the protective shield may be a rain coat, a thermal blanket, or a solar blanket. Preferably, a leg strap is attached to an aft end of the protective shield and is configured to be secured around a hind leg of the pet. The leg strap may have at least one free end that is releasably secured around the hind leg of the pet with a fastener operable from an outer flank portion of the pet.

These and other features, aspects and advantages of the present invention will become better understood with reference to the following drawings, description and claims.

### BRIEF DESCRIPTION OF THE DRAWINGS

FIG. 1 is a perspective view of an embodiment of a pet restraint, shown in use with protective shield stored.

FIG. 2 is a perspective view of the pet restraint, shown in use with protective shield deployed.

FIG. 3 is a front perspective view of the pet restraint.

FIG. 4 is a rear perspective view of the pet restraint.

FIG. 5 is a section view of the pet restraint, taken along line 5-5 in FIG. 3.

FIG. 6 is a section view of the pet restraint, with the protective shield in the extended position.

FIG. 7 is a front perspective view of an alternate embodiment of the pet restraint.

FIG. 8 is a rear perspective view of an alternate embodiment of the pet restraint.

FIG. 9 is a rear perspective view of a protective shield with leg straps.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a pet restraint, such as a collar, or a harness, that has an integrally formed pouch, or pocket, attached to the restraint. The pouch is adapted to contain an environmentally protective shield for the pet. A pet owner may readily deploy the protective shield to outfit their pet to be protected from adverse environmental conditions, such as rain and cold.

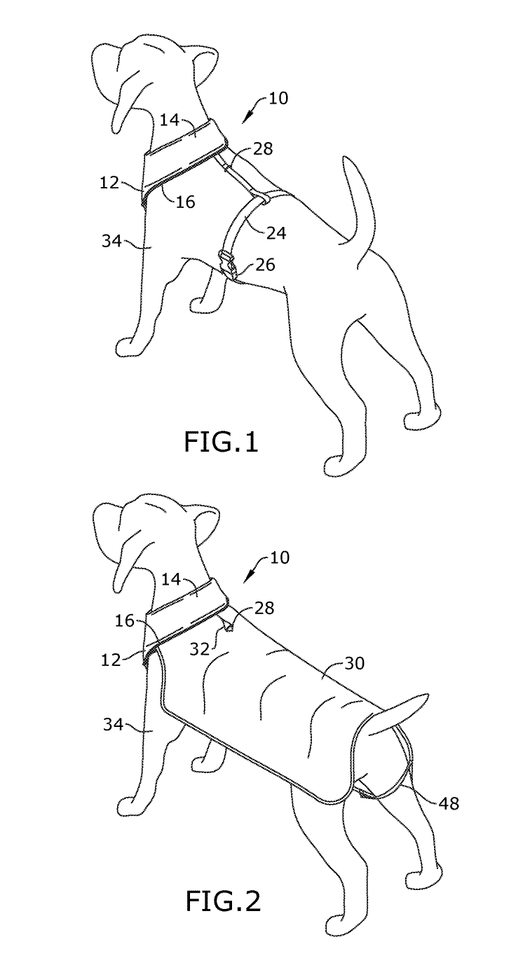

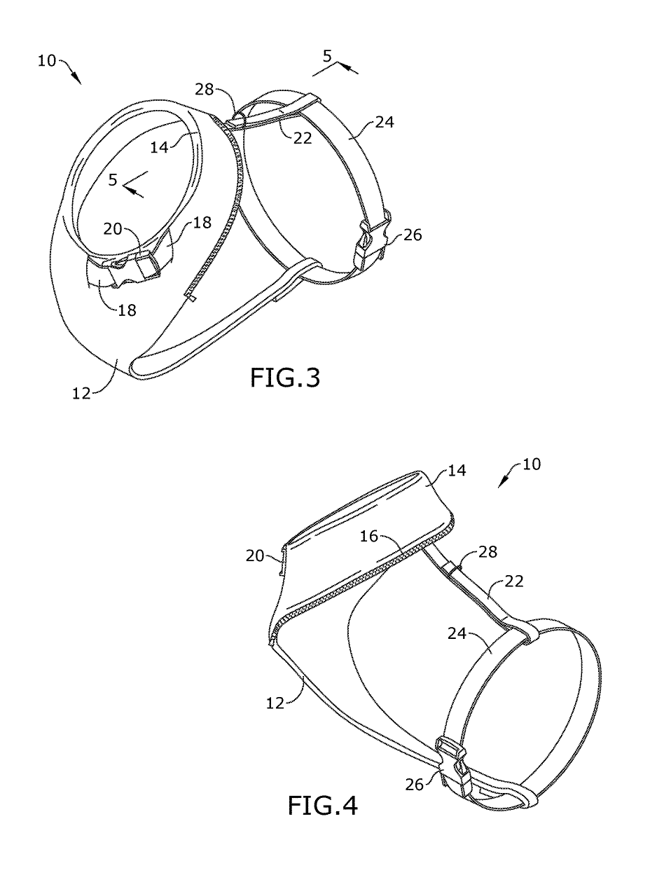

Referring now to FIGS. 1 through 8, embodiments of a pet restraint with built in protective shield 10 are shown. FIG. 1 depicts an overhead perspective view of an embodiment of the present invention contained in a harness type pet restraint 10. The harness 10 includes a collar 18, for encircling and providing restraint around a pet's neck, and a torso band 24 for encircling and providing added restraint around a pet's torso. A chest portion 12 operatively connects the collar 18 and torso band 24 and extends across the pets chest and between the pet's forelegs. A back strap 22, operatively connects the collar 18 and torso band and extends along the pet's spine. The collar 18 has a buckle 20 for adjusting the length of the collar strap to fit around the neck of the pet 34. Similarly, the torso band 24 has a buckle 26 for adjusting the length of the torso band 24 to the pet 34.

As seen in reference to FIGS. 1 and 2, a pouch 14 is operatively attached to the collar 18 at a top portion of the collar 18, so that it is positioned at the base of the neck, and aligned with the pet's spine. The pouch 14 may include a restraint ring 28 at a top or forward edge of the pouch 14 which permits subsequent attachment to a leash for walking the pet 34, or to a restraint system that may attached to a structure or the ground in order keep the pet 34 within a defined area. The restraint ring 28 may alternatively be attached to the collar 18 or the back strap 22. The pouch 14 further includes an opening that may be selectively opened and closed by a fastener 16, such as a zipper or slide fastener, snaps, buttons, or hook-and-pile fasteners.

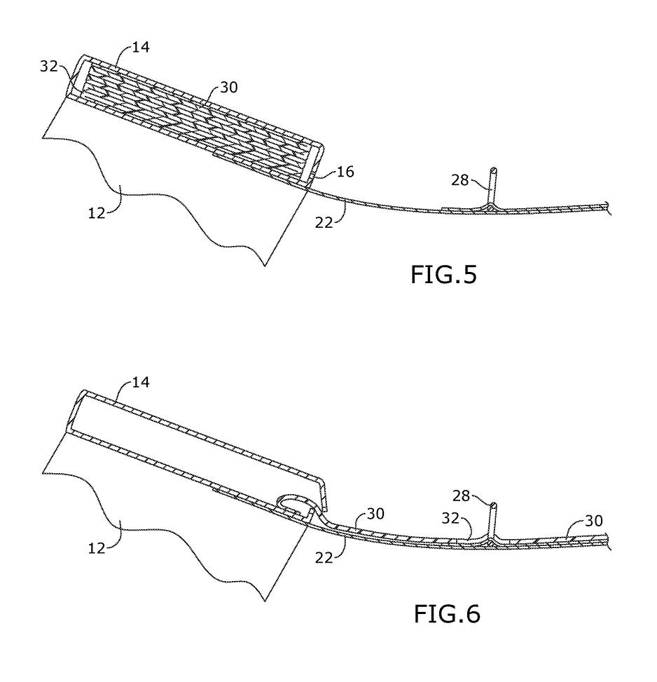

Referring to FIGS. 5 and 6, the pouch 14 is depicted in a stowed and a deployed condition. In the stowed condition, the shield 30 is folded onto itself for containment within the cavity 31. In the open position, the cavity 31 within the pouch 14 is more clearly seen as well as the attachment of a forward end of the protective shield 30 to the inside of the pouch 14. In those instances where the restraint ring 28 is attached to the back strap 22, the protective shield 30 may also be provided with a ring slot 32 to provide passage for restraint ring 28 through the protective shield 30 so that the pet owner can attach the restraint, such as a leash.

Referring to FIGS. 2 and 6, the protective shield 30 is shown in a deployed condition, and further illustrates the attachment of a forward end of the shield 30 within the pouch 14 cavity. The shield 30 has a predetermined length and width, corresponding to the size of the pet 34 the owner wishes to outfit. As seen in FIGS. 2 and 9, a pair of leg straps may be provided proximal to an aft end of the protective shield 30 and at left and right sides thereof. With the forward end of the shield 30 secured to the pet's neck area, the leg straps may be utilized to secure and retain the protective shield 30 over the pet's back in order to keep the shield 30 positioned and protecting the pet 34 from the elements. In other embodiments, a belly strap may be utilized to secure the protective shield 30 on the pets back. The belly strap may extend between lateral sides of the protective shield 30 and beneath the pet's belly or torso.

In reference to FIG. 9, showing a detailed view of a leg strap 48, the strap 48 is attached to the shield 30 at one end and is removably secured to the shield 30 at another end via a fastener. To facilitate securement of the straps 48 around the pet's hind legs, the forward (outer) ends of the straps are provided with the fastener, so that the owner can readily access it from the pet's outer flanks, rather than having to work the fastener's attachment between their pet's legs. Preferably the leg strap 48 is adjustable, such as by an elastic band, to accommodate various size pet legs and to permit the pet 34 to move its legs with minimal restriction as it embarks on its walk with the protective shield 30 deployed.

In the presently preferred embodiment, the shield 30 is comprised of a flexible water repellant material, such as those suitable for a raincoat, to provide protection from liquid precipitation. Alternatively, the shield 30 may be comprised of a thermally protective blanket to provide the pet protection from the cold, or frozen precipitation or a highly reflective material to protect from the sun's rays on particularly hot days. The shield 30 may also combine a water repellant and thermally protective blanket, to provide protection on cold and rainy days. The protective shield 30 may also be removably attached to the pouch 14 to permit selective attachment of a shield 30 suited to prevailing seasonal conditions.

The present invention is particularly suited for pets 34 that are reluctant to their owner's donning them with protective gear or other pet fashion wear, particularly those requiring donning over the head of the pet 34. Because the forward portion of the protective shield 30 remains operatively attached to the pet harness 10, and thereby the pet 34, the pet's owner need only deploy the protective shield 30 from the harness and secure the shield 30 to the pet's hind legs. Similarly, because the pet 34 becomes accustomed to the presence and weight of the shield 30 within the pouch 14, subsequent deployment and donning of the shield 30 become less stressful for the pet 34 and less burdensome on the pet owner.

As should be evident from the foregoing description, the protective shield 30 may be easily deployed from the pouch 14 when it is required. Moreover, the shield 30 may be conveniently stowed back in the pouch 14 when the inclement weather clears or when the pet 34 and owner have returned to the safety of their home.

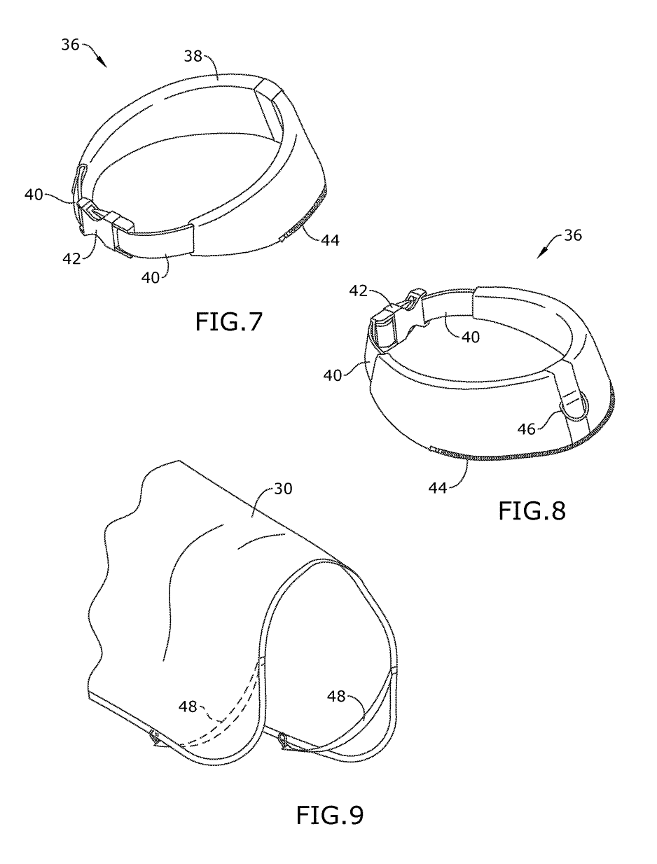

As seen in reference to FIGS. 7 and 8, an alternative embodiment of the pet restraint with built in protective shield 36 of the present invention is illustrated. In this embodiment, the restraint has a collar 40 to which the pouch 38 is attached. As with the previous embodiment, the pouch 38 has a fastener 44, such as a zipper, to provide access the interior of the pouch 36 containing the protective shield 30 carried therein. The collar has a buckle 42 to adjust and secure the collar 40 about the neck of the pet 34. The pet restraint 36 will also have a restraint ring 46 operatively attached to the pouch 38. The shield 30 may be otherwise deployed and stowed as in the previous embodiment.

It should be understood, of course, that the foregoing relates to exemplary embodiments of the invention and that modifications may be made without departing from the spirit and scope of the invention as set forth in the following claims.

What is claimed is:

1. A pet restraint, comprising:
a collar configured to be releasably secured around a neck of a pet;
a pouch secured to a top portion of the collar, the pouch having an interior cavity defined therein and an opening between an exterior of the pouch and the interior cavity; and
a protective shield having a front portion attached within the interior cavity and an aft portion that is selectably deployed between a stowed condition within the pouch and a deployed condition to substantially cover a back of the pet.

2. The pet restraint of claim 1, wherein the opening is selectively opened and closed by a fastener.

3. The pet restraint of claim 2, wherein the fastener is a zipper.

4. The pet restraint of claim 2, wherein the fastener is a hook and pile fastener.

5. The pet restraint of claim 2, wherein the fastener is a snap.

6. The pet restraint of claim 2, further comprising:
a torso band configured to be releasably secured around a torso of the pet; and
a back strap interconnecting the torso band and the collar.

7. The pet restraint of claim 6, further comprising:
a chest portion attached to a lower portion of the collar and extending to interconnect with a bottom portion of the torso band.

8. The pet restraint of claim 6, further comprising:
a restraint ring operatively attached to the pet restraint.

9. The pet restraint of claim 8, wherein the restraint ring is attached to the top portion of the collar.

10. The pet restraint of claim 8, wherein the restraint ring is attached to the back strap.

11. The pet restraint of claim 8, wherein the restraint ring is attached to a top portion of the pouch.

12. The pet restraint of claim 1, wherein the protective shield comprises a rain coat.

13. The pet restraint of claim 1, wherein the protective shield is comprises a thermal blanket.

14. The pet restraint of claim 1, wherein the protective shield comprises a solar blanket.

15. The pet restraint of claim 1, further comprising:
a leg strap attached to an aft end of the protective shield the leg strap configured to be secured around a hind leg of the pet.

16. The pet restraint of claim 14, wherein the leg strap has at least one free end that is releasably secured around the hind leg of the pet with a fastener operable from an outer flank of the pet.
